(19) United States
(12) Patent Application Publication
(10) Pub. No.: US 2023/0118586 A1
(43) Pub. Date: Apr. 20, 2023

(54) REFERENCE SIGNAL TRANSMISSION BY FULL-DUPLEX USER EQUIPMENT

(71) Applicants: Min Huang, San Diego, CA (US); Chao Wei, San Diego, CA (US); Jing Dai, San Diego, CA (US); QUALCOMM Incorporated, San Diego, CA (US)

(72) Inventors: Min Huang, Beijing (CN); Chao Wei, Beijing (CN); Jing Dai, Beijing (CN)

(21) Appl. No.: 17/905,885

(22) PCT Filed: Mar. 13, 2020
(86) PCT No.: PCT/CN2020/079182

§ 371 Date: Sep. 8, 2022

(51) Int. Cl. H04L 5/14; H04L 5/00

(52) U.S. Cl. CPC H04L 5/1438; H04L 5/0062; H04L 5/0051

(57) ABSTRACT

This disclosure provides systems, methods, and apparatuses, including computer programs encoded on computer storage media, for wireless communication. In one aspect of the disclosure, a method of wireless communication includes receiving, at a user equipment (UE) from a network entity, a resource configuration message. The resource configuration message includes a first parameter corresponding to full duplex (FD) uplink (UL) and a second parameter corresponding to FD downlink (DL). The method further includes transmitting, from the UE to the network entity, a FD reference signal based on the resource configuration message. Other aspects and features are also claimed and described.

### TECHNICAL FIELD

Aspects of the present disclosure relate generally to wireless communication systems, and more particularly, but without limitation, to reference signal transmission by full-duplex user equipment.

### DESCRIPTION OF THE RELATED TECHNOLOGY

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the third (3^{rd}) Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

In some wireless communication systems, a UE may transmit a reference signal to a base station as part of an uplink (UL) beam determination and scheduling process. For example, the UE may transmit one or more sounding reference signals (SRSs) to the base station via one or more UL beams. The base station determines one or more UL beams to schedule for the UE based on channel gains of the one or more SRSs. For example, the base station may select UL beams of the SRSs with the highest channel gains in order to improve UL signal quality and throughput.

Fifth generation (5G) wireless networks are expected to provide ultra-high data rates and support a wide scope of application scenarios. To support such high data rates, one proposed technique is full-duplex (FD) communications. In FD communications, radio nodes are configured to transmit and receive signals concurrently on the same frequency band and in the same time slot. FD communications have been proposed for UEs, such that a UE may concurrently transmit and receive signals, thereby increasing the aggregated UL and downlink (DL) throughput at the UE. One important aspect of enabling FD communications at a UE is to cancel (or reduce) self-interference from the DL to the UL. However, current UL beam scheduling processes only select the UL beams based on UL channel gains, which may cause strong self-interference to a received DL signal, reducing DL throughput and potentially causing DL transmission failure.

### SUMMARY

The systems, methods and devices of this disclosure each have several innovative aspects, no single one of which is solely responsible for the desirable attributes disclosed herein. One innovative aspect of the subject matter described in this disclosure can be implemented in a method of wireless communication. The method includes receiving, at a user equipment (UE) from a network entity, a resource configuration message. The resource configuration message includes a first parameter corresponding to full duplex (FD) uplink (UL) and a second parameter corresponding to FD downlink (DL). The method further includes transmitting, from the UE to the network entity, a FD reference signal based on the resource configuration message.

Another innovative aspect of the subject matter described in this disclosure can be implemented in an apparatus configured for wireless communication. The apparatus includes at least one processor and a memory coupled to the at least one processor. The at least one processor is configured to receive, at a user equipment (UE) from a network entity, a resource configuration message. The resource configuration message includes a first parameter corresponding to full duplex (FD) uplink (UL) and a second parameter corresponding to FD downlink (DL). The at least one processor is further configured initiate transmission, from the UE to the network entity, of a FD reference signal based on the resource configuration message.

Another innovative aspect of the subject matter described in this disclosure can be implemented in an apparatus configured for wireless communication. The apparatus includes means for receiving, at a user equipment (UE) from a network entity, a resource configuration message. The resource configuration message includes a first parameter corresponding to full duplex (FD) uplink (UL) and a second parameter corresponding to FD downlink (DL). The apparatus further includes means for transmitting, from the UE to the network entity, a FD reference signal based on the resource configuration message.

Another innovative aspect of the subject matter described in this disclosure can be implemented in a non-transitory computer-readable medium storing instructions that, when executed by a processor, cause the processor to perform operations including receiving, at a user equipment (UE) from a network entity, a resource configuration message. The resource configuration message includes a first parameter corresponding to full duplex (FD) uplink (UL) and a second parameter corresponding to FD downlink (DL). The operations further include initiating transmission, from the UE to the network entity, of a FD reference signal based on the resource configuration message.

Another innovative aspect of the subject matter described in this disclosure can be implemented in a method of wireless communication. The method includes transmitting, from a network entity to a user equipment (UE), a resource configuration message. The resource configuration message includes a first parameter corresponding to full duplex (FD) uplink (UL) and a second parameter corresponding to FD downlink (DL). The method also includes receiving, at the network entity from the UE, a FD reference signal based on the resource configuration message.

Another innovative aspect of the subject matter described in this disclosure can be implemented in an apparatus configured for wireless communication. The apparatus includes at least one processor and a memory coupled to the at least one processor. The at least one processor is configured to initiate transmission, from a network entity to a user equipment (UE), of a resource configuration message. The resource configuration message includes a first parameter corresponding to full duplex (FD) uplink (UL) and a second parameter corresponding to FD downlink (DL). The at least one processor is also configured to receive, at the network entity from the UE, a FD reference signal based on the resource configuration message.

Another innovative aspect of the subject matter described in this disclosure can be implemented in an apparatus configured for wireless communication. The apparatus includes means for transmitting, from a network entity to a user equipment (UE), a resource configuration message. The resource configuration message includes a first parameter corresponding to full duplex (FD) uplink (UL) and a second parameter corresponding to FD downlink (DL). The apparatus further includes means for receiving, at the network entity from the UE, a FD reference signal based on the resource configuration message.

Another innovative aspect of the subject matter described in this disclosure can be implemented in a non-transitory computer-readable medium storing instructions that, when executed by a processor, cause the processor to perform operations including initiating transmission, from a network entity to a user equipment (UE), of a resource configuration message. The resource configuration message includes a first parameter corresponding to full duplex (FD) uplink (UL) and a second parameter corresponding to FD downlink (DL). The operations further include receiving, at the network entity from the UE, a FD reference signal based on the resource configuration message.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a block diagram illustrating details of an example wireless communication system.

FIG. 2 is a block diagram conceptually illustrating an example design of a base station and a user equipment (UE).

FIG. 3 is a block diagram illustrating an example wireless communication system for enabling a UE to operate in a full-duplex (FD) mode with reduced (or eliminated) self-interference.

FIG. 4 is a ladder diagram illustrating an example wireless communication system for enabling a UE to operate in a FD mode with reduced (or eliminated) self-interference.

FIG. 5 is a flow diagram illustrating an example process of UE operations for communication.

FIG. 6 is a flow diagram illustrating an example process of network entity operations for communication.

FIG. 7 is a block diagram conceptually illustrating a design of a UE.

FIG. 8 is a block diagram conceptually illustrating a design of a network entity.

The Appendix provides further details regarding various aspects of this disclosure and the subject matter therein forms a part of the specification of this application.

Like reference numbers and designations in the various drawings indicate like elements.

### DETAILED DESCRIPTION

The following description and appendix is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

The present disclosure provides systems, apparatus, methods, and computer-readable media for reducing (or eliminating) self-interference from an uplink (UL) channel to a downlink (DL) channel for a full-duplex (FD) UE, thereby enabling FD communications at the UE. For example, the techniques described herein provide a reference signal transmission scheme for a FD UE that enables to FD UE to determine a UL reference signal beam that not only enhances the gain of the UL channel, but also reduces the self-interference to the DL channel. To illustrate, a UE may receive, from a network entity (such as a base station), a resource configuration message that includes a first parameter corresponding to FD UL and a second parameter corresponding to FD DL. The UE may transmit a FD reference signal based on the resource configuration message.

Instead of simply selecting the UL beam to transmit the FD reference signal based on UL gain to the base station, the UE selects the UL beam based on UL gain and based on reducing self-interference. For example, the UE may select a UL beam that maximizes a signal-to-interference and noise ratio (SINR) of a first received signal while also ensuring that self-interference to a second received signal caused by a transmitted signal is less than a threshold. Additionally, or alternatively, the UE may select a UL beam that minimizes a correlation coefficient between a transmission beam and the UL beam used to transmit the FD reference signal while also ensuring that self-interference to a received signal caused by the transmitted signal is less than a threshold. In this manner, the UE selects UL beams for transmission of FD reference signals (e.g., sounding reference signals (SRSs)) that improve UL gain and that reduce self-interference to DL signals at the UE.

Particular implementations of the subject matter described in this disclosure can be implemented to realize one or more of the following potential advantages. In some aspects, the present disclosure provides a process and techniques for determining UE reference signals, and the UL beams via which to transmit the reference signals, that reduce self-interference with DL signals at the UE. This may enable FD communications at the UE and improve DL throughput in the FD mode as well as reducing (or eliminating) DL transmission failure in the FD mode.

This disclosure relates generally to providing or participating in authorized shared access between two or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS/GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ˜1M nodes/km²), ultra-low complexity (such as ˜10 s of bits/sec), ultra-low energy (such as ˜10+ years of battery life), and deep coverage with the capability to reach challenging locations; (2) including mission-critical control with strong security to safeguard sensitive personal, financial, or classified information, ultra-high reliability (such as ˜99.9999% reliability), ultra-low latency (such as ˜1 millisecond (ms)), and users with wide ranges of mobility or lack thereof; and (3) with enhanced mobile broadband including extreme high capacity (such as ˜10 Tbps/km²), extreme data rates (such as multi-Gbps rate, 100+Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

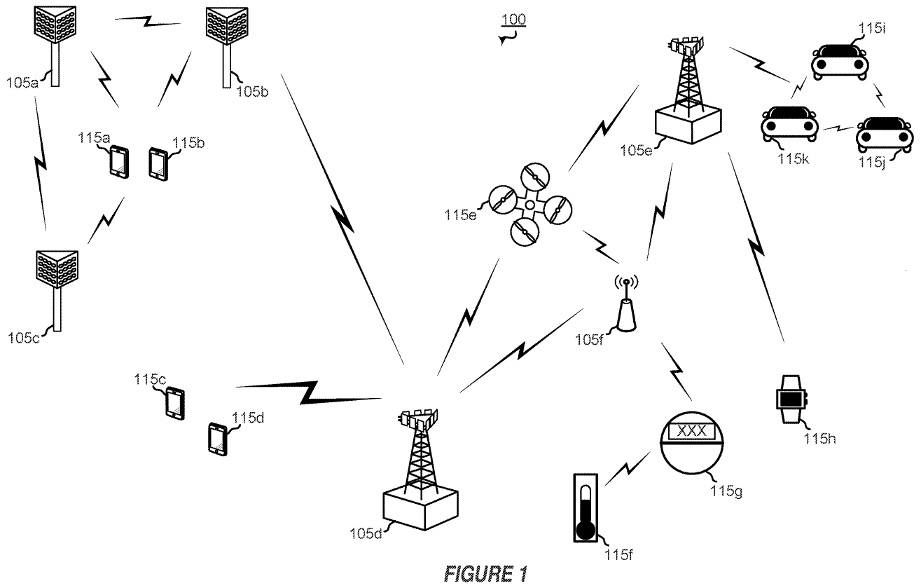

FIG. 1 is a block diagram illustrating details of an example wireless communication system. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device to device or peer to peer or ad hoc network arrangements, etc.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a -105c are macro base stations enabled with one of 3 dimension (3D), full dimension (FD), or massive MIMO. Base stations 105a -105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3rd Generation Partnership Project (3GPP), such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (such as MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a -115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e -115k illustrated in FIG. 1 are examples of various machines configured for communication that access 5G network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a -105c serve the UEs 115a and 115b using 3D beamforming and coordinated spatial techniques, such as coordinated multipoint (CoMP) or multi-connectivity. Macro base station 105d performs backhaul communications with the base stations 105a -105c , as well as small cell, the base station 105f . Macro base station 105d also transmits multicast services which are subscribed to and received by the UEs 115c and 115d . Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e , which is a drone. Redundant communication links with the UE 115e include from the macro base stations 105d and 105e , as well as small cell base station 105f . Other machine type devices, such as UE 115f (thermometer), the UE 115g (smart meter), and the UE 115h (wearable device) may communicate through the wireless network 100 either directly with base stations, such as the small cell base station 105f , and the macro base station 105e , or in multi-hop configurations by communicating with another user device which relays its information to the network, such as the UE 115f communicating temperature measurement information to the smart meter, the UE 115g , which is then reported to the network through the small cell base station 105f . The 5G network 100 may provide additional network efficiency through dynamic, low-latency TDD/FDD communications, such as in a vehicle-to-vehicle (V2V) mesh network between the UEs 115i-115k communicating with the macro base station 105e.

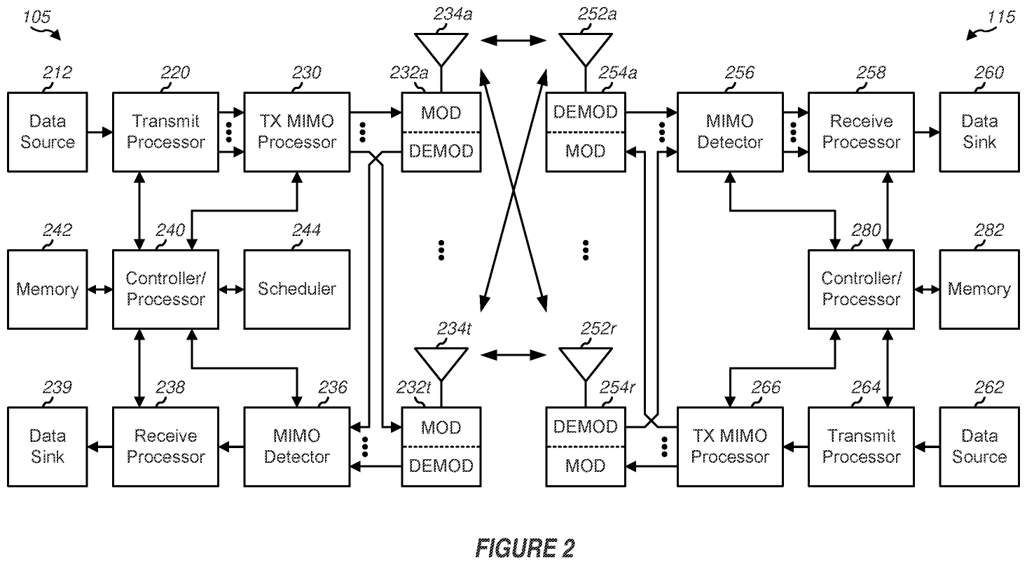

FIG. 2 is a block diagram conceptually illustrating an example design of a base station 105 and a UE 115. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f , which in order to access the small cell base station 105f , would be included in a list of accessible UEs for the small cell base station 105f . Additionally, the base station 105 may be a base station of some other type. As shown in FIG. 2, the base station 105 may be equipped with antennas 234a through 234t , and the UE 115 may be equipped with antennas 252a through 252r for facilitating wireless communications.

At the base station 105, a transmit processor 220 may receive data from a data source 212 and control information from a controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t . For example, spatial processing performed on the data symbols, the control symbols, or the reference symbols may include precoding. Each modulator 232 may process a respective output symbol stream, such as for OFDM, etc., to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t , respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, etc., to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a controller/processor 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the controller/processor 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, etc.), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the controller/processor 240.

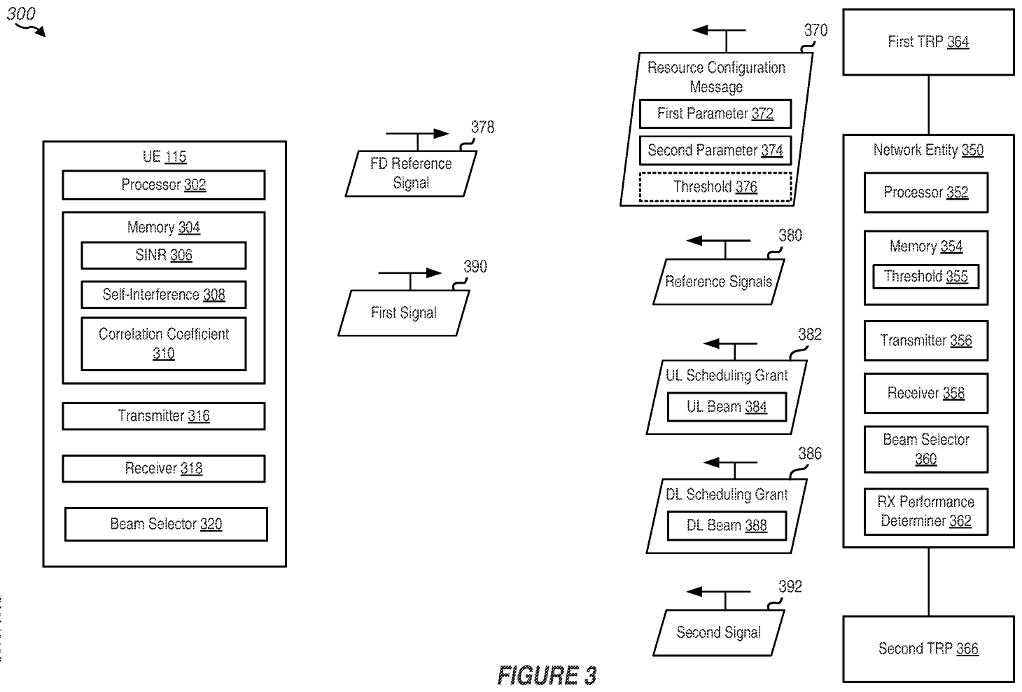

The controllers/processors 240 and 280 may direct the operation at the base station 105 and the UE 115, respectively. The controller/processor 240 or other processors and modules at the base station 105 or the controller/processor 280 or other processors and modules at the UE 115 may perform or direct the execution of various processes for the techniques described herein, such as to perform or direct the execution illustrated in FIGS. 3-7, or other processes for the techniques described herein. The memories 242 and 282 may store data and program codes for the base station 105 and The UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge/negative-acknowledge (ACK/NACK) feedback for its own transmitted packets as a proxy for collisions.

In some wireless communication systems, to determine an uplink (UL) beam (e.g., beam direction, beam weight, etc.) and UL scheduling (e.g., resource assignment, transport format, modulation and coding scheme (MCS), number of layers, etc.), a UE typically transmits one or more sounding reference signals (SRSs) to a base station. The base station determines one or more UL beams for scheduling based on the channel gains of the one or more SRSs (e.g., the base station selects the beams of the SRSs with the highest channel gains). The base station then indicates the selected beams in a UL scheduling grant, and the UE is required to transmit UL data channels (like a physical uplink shared channel (PUSCH)) via the designated UL beams. In a current fifth generation (5G) wireless communication standard, the base station configures SRS resources to a UE in radio resource control (RRC) signaling such that each SRS resource has an attribute—a spatial relation information attribute which contains an index of only one reference signal. If the UE is indicated to transmit SRS in a certain SRS resource, the UE should use the beam that is in correspondence with the indicated reference signal. For example, if a synchronization signal block (SSB) index or a channel state information reference signal (CSI-RS) index is included, the UE transmits the SRS along the beam that is used to receive the SSB or the CSI-RS in the corresponding SSB resource or the CSI-RS resource. If a SRS resource is included, the UE transmits the SRS along the beam that is used to transmit the SRS in the corresponding SRS resource.

In a physical downlink shared channel (PDSCH) configuration message, a base station may indicate a number of transmission configuration information (TCI) states. A TCI state includes one or more quasi co-location (QCL) information. Each QCL information is associated with a cell ID, a bandwidth part (BWP) ID, a reference signal identifier (such as a SSB index or a CSI-RS resource ID), and a QCL type. Different QCL types mean different degrees of co-location between PDSCH and the associated reference signal (e.g., QCL-D type means the PDSCH and the associated reference signal are received with the same spatial receive (RX) parameter, such as the same RX beam).

In a current 5G wireless communication standard, transmission in multi-transmission-receive points (TRPs) is discussed. For example, a base station may connect to multiple geographically-distributed TRPs, and these TRPs can separately or jointly transmit signals to one or more UEs or receive signals from one or more UEs. To further illustrate, a base station can transmit signals from different TRPs to a UE on multiple PDSCH links, which can enhance diversity gain, downlink (DL) system capacity, and/or DL cell coverage. A UE that communicates with multiple TRPs may be equipped with multiple panels (e.g., antenna panels) such that one panel is used to point to one TRP.

5G wireless networks are expected to provide ultra-high data rates and support a wide scope of application scenarios. Wireless full-duplex (FD) is a technique to improve link capacity by enabling radio network nodes to transmit and receive concurrently on the same frequency band and at the same time slot (as compared to half-duplex communications, where transmission and reception either differ in time or in frequency). A new emerging technology is a FD-capable UE, or FD UE, which is configured to concurrently transmit and receive wireless signals using the same time and frequency resources. FD mode at a UE improves aggregated DL and UL throughput at the UE if it can be implemented. One difficulty with FD communications at the UE is self-interference from the UL to the DL. Some self-interference can be cancelled by combining the technologies of beamforming, analog cancellation, digital cancellation, and antenna cancellation.

One example of a UE operating in FD mode is with a base station equipped with multiple TRPs. Each TRP can transmit or receive signals to/from the UE. For example, a base station may use two TRPs to communicate with one FD UE (e.g., a UE equipped with multiple panels, so it may operate in FD mode). One panel is used to receive a signal from one TRP (referred to as a DL TRP) and the other panel is used to transmit a signal to the other TRP (referred to as a UL TRP). The transmitting and receiving operations are in FD (e.g., overlap in frequency and time). Due to different product designs and hardware/software implementation, the capabilities of mitigating self-interference by each FD-capable UE may be different. For example, in some cases, the capability is fixed, in other cases, the capability is variant with the UE's transmission power, transmission bandwidth, transmission beamforming (e.g., precoding) weights, or other factors.

Additional difficulties with mitigating self-interference are currently preventing FD-capable UEs from achieving acceptance. For example, as explained above, when scheduling a UL beam for a UE, only the UL gain of the target link is considered. To illustrate, a base station may transmit a SRS configuration message to a UE, the SRS configuration message indicating a spatial relation parameter to guide the UE in transmitting the SRS. The UE then transmits the SRS with a determined SRS beam based on the reception of a reference signal from the base station, which is associated with the spatial relation parameter in the SRS configuration message. Additionally, the PUSCH signal that is transmitted along with the beam of the SRS is selected only considering to enhance the target link (e.g., improve the UL gain). When the UE is working in FD mode, only considering the UL gain when selecting the UL beam can cause strong self-interference with a received DL signal from the DL TRP. This self-interference can cause DL transmission failure and reduce DL throughput in the FD mode.

The present disclosure provides systems, apparatus, methods, and computer-readable media for reducing (or eliminating) self-interference from an uplink (UL) channel to a downlink (DL) channel for a full-duplex (FD) UE, thereby enabling FD communications at the UE. For example, the techniques described herein provide a reference signal transmission scheme for a FD UE that enables to FD UE to determine a UL reference signal beam that not only enhances the gain of the UL channel, but also reduces the self-interference to the DL channel. Determining UE reference signals, and the UL beams via which to transmit the reference signals, that reduce self-interference with DL signals at the UE enables FD communications at the UE and improves DL throughput in the FD mode as well as reduces (or eliminates) DL transmission failure in the FD mode.

FIG. 3 is a block diagram illustrating an example wireless communications system 300 for enabling a UE to operate in a FD mode with reduced (or eliminated) self-interference. In some examples, the wireless communications system 300 may implement aspects of the wireless network 100. The wireless communications system 300 includes the UE 115 and a network entity 350. The network entity 350 may include or correspond to the base station 105, a network, a network core, or another network device, as illustrative, non-limiting examples. Although one UE and one network entity are illustrated, in some other implementations, the wireless communications system 300 may include more than one UE, more than one network entity, or a combination thereof. As described herein, the present disclosure provides a process and techniques for a UE to operate in a FD mode with reduced (or eliminated) self-interference. Accordingly, the UE 115 may select a UL transmission beam for sending a FD reference signal that balances between the competing interests of improving UL signal quality and reducing self-interference with a DL reception beam at the UE 115.

The UE 115 can include a variety of components (such as structural, hardware components) used for carrying out one or more functions described herein. For example, these components can include a processor 302, a memory 304, a transmitter 316, a receiver 318, and a beam selector 320. The processor 302 may be configured to execute instructions stored at the memory 304 to perform the operations described herein. In some implementations, the processor 302 includes or corresponds to the controller/processor 280, and the memory 304 includes or corresponds to the memory 282.

The memory 304 may include a signal-to-interference and noise ratio (SINR) 306, a self-interference 308 (e.g., a self-interference measurement), a correlation coefficient 310, or a combination thereof. The SINR 306 may be generated based on a first reference signal (e.g., a first synchronization signal block (SSB) or a first channel state information reference signal (CSI-RS)) received via a reception beam, as further described herein. The self-interference 308 may be determined by measuring an interference caused to a reference signal (e.g., a SSB or a CSI-RS) received via a reception beam that is caused by a transmission signal transmitted via a transmission beam, as further described herein. The correlation coefficient 310 may be between a transmission beam used to transmit a signal and a transmission beam used to transmit a SRS in a SRS resource, as further described herein.

The transmitter 316 is configured to transmit data to one or more other devices, and the receiver 318 is configured to receive data from one or more other devices. For example, the transmitter 316 may transmit data, and the receiver 318 may receive data, via a network, such as a wired network, a wireless network, or a combination thereof. For example, the UE 115 may be configured to transmit or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, the transmitter 316 and the receiver 318 may be replaced with a transceiver. Additionally, or alternatively, the transmitter 316, the receiver 318, or both may include and correspond to one or more components of the UE 115 described with reference to FIG. 2.

The beam selector 320 is configured to select a UL transmission beam for use in transmitting a reference signal to the network entity 350. For example, the beam selector 320 may be configured to select the UL transmission beam (either by determining or selecting from a plurality of preconfigured UL transmission beams) based on a resource configuration message, as further described herein.

The UE 115 may include multiple panels (e.g., antenna panels) for supporting FD communications. For example, the UE 115 may include a first panel (e.g., a UL panel) configured to transmit one or more signals to the network entity 350 and a second panel (e.g., a DL panel) configured to receive one or more signals from the network entity 350. The panels may be configured such that the corresponding signals use at least some of the same time and frequency resources. For example, at least a portion of a signal transmitted by the first panel may overlap in time with at least a portion of a signal transmitted by the second panel, at least a portion of the signal transmitted by the first panel may overlap in frequency with at least a portion of the signal received by the second panel, or both. In this manner, FD communications may be supported at the UE 115.

The network entity 350 can include a variety of components (such as structural, hardware components) used for carrying out one or more functions described herein. For example, these components can include a processor 352, a memory 354, a transmitter 356, a receiver 358, a beam selector 360, and a reception (RX) performance determiner 362. The processor 352 may be configured to execute instructions stored at the memory 354 to perform the operations described herein. In some implementations, the processor 352 includes or corresponds to the controller/processor 240, and the memory 354 includes or corresponds to the memory 242.

The transmitter 356 is configured to transmit data to one or more other devices, and the receiver 358 is configured to receive data from one or more other devices. For example, the transmitter 356 may transmit data, and the receiver 358 may receive data, via a network, such as a wired network, a wireless network, or a combination thereof. For example, the network entity 350 may be configured to transmit or receive data via a direct device-to-device connection, a LAN, a WAN, a modem-to-modem connection, the Internet, intranet, extranet, cable transmission system, cellular communication network, any combination of the above, or any other communications network now known or later developed within which permits two or more electronic devices to communicate. In some implementations, the transmitter 356 and the receiver 368 may be replaced with a transceiver. Additionally, or alternatively, the transmitter 356, the receiver 358 or both may include and correspond to one or more components of base station 105 described with reference to FIG. 2.

The beam selector 360 is configured to select a UL transmission beam, a DL reception beam, or both, for scheduling for the UE 115. For example, the beam selector 360 may be configured to select the UL transmission beam based on a reference signal received from the UE 115, as further described herein. Additionally, the beam selector 360 may be configured to select the DL reception beam based on a parameter of a resource configuration message, as further described herein. The RX performance determiner 362 is configured to determine RX performance at the network entity 350. For example, the RX performance determiner 362 may be configured to determine RX performance based on a UL transmission beam used to transmit a reference signal from the UE 115 to the network entity 350, as further described herein.

The network entity 350 may be coupled to one or more transmit-receive points (TRPs). The one or more TRPs are configured to separately, or jointly, transmit or receive signals to one or more other devices. If multiple TRPs are used to transmit data to a single device (e.g., the UE 115), the data may be transmitted via multiple physical downlink shared channels (PDSCHs), which improves diversity gain, DL system capacity, and/or DL cell coverage. In the example of FIG. 3, the network entity 350 is coupled to a first TRP 364 and to a second TRP 366. The TRPs 364-366 may be configured to transmit signals or to receive signals. For example, the first TRP 364 may be a UL TRP that is configured to receive signals from one or more other devices, such as the UE 115, and to provide the received signals to the network entity 350. Additionally, the second TRP 366 may be DL TRP that is configured to receive signals from the network entity 350 and to transmit the signals to one or more other devices, such as the UE 115.

In some implementations, the wireless communications system 300 includes a 5G network. For example, the UE 115 may include a 5G UE, such as a UE configured to operate in accordance with a 5G network. The network entity 350 may include a 5G base station, such as a base station configured to operate in accordance with a 5G network.

During operation of the wireless communications system 300, the network entity 350 generates a resource configuration message 370. In some implementations, the resource configuration message 370 includes or corresponds to a SRS resource configuration message. The resource configuration message 370 includes (or indicates) a first parameter 372 and a second parameter 374. The first parameter 372 corresponds to FD UL and the second parameter 374 corresponds to FD DL. The resource configuration message 370 that a reference signal selected by the UE 115 for a corresponding reference signal resource should increase (or maximize) a gain of a UL channel based on the first parameter 372 for a UL TRP (e.g., the first TRP 364) while reducing (or minimizing) the self-interference to a DL channel based on the second parameter 374 for a DL TRP (e.g., the second TRP 366).

In some implementations, the first parameter 372 includes a spatial relation parameter, the second parameter 374 includes a transmission configuration information (TCI) parameter, or both. The spatial relation parameter may correspond to FD UL, and the TCI parameter may correspond to FD DL. In some implementations, the spatial relation parameter (e.g., the first parameter 372) includes or indicates an identifier of a first synchronization signal block (SSB) resource, an identifier of a first channel state information reference signal (CSI-RS) resource, or an identifier of a SRS resource. Additionally, or alternatively, the TCI parameter (e.g., the second parameter 374) may include or indicate an identifier of a second SSB resource or a second CSI-RS resource. The spatial relation parameter and the TCI parameter may be used by the UE 115 to determine a reference signal to transmit to the network entity 350, as further described herein.

In some implementations, the resource configuration message 370 also includes a threshold 376. The threshold 376 may be a self-interference strength threshold. In some implementations, the self-interference strength threshold (e.g., the threshold 376) includes an absolute power value. For example, the threshold 376 may include an absolute power value, such as −160 dBm as a non-limiting example, which indicates that the self-interference power from the UL to the DL should not exceed −160 dBm per physical resource block (PRB). In some other implementations, the self-interference strength threshold (e.g., the threshold 376) includes a relative power value. For example, the threshold 376 may include a relative power value, such as 3 dB as a non-limiting example, which indicates that the self-interference power from UL to DL should not exceed the non-FD-mode interference power plus 3 dB. In this example, the non-FD-mode refers to the operation in which only DL data transfer is performed, without concurrent UL data transfer by the same UE.

After generating the resource configuration message 370, the network entity 350 transmits the resource configuration message 370 to the UE 115, and the UE 115 receives the resource configuration message 370 from the network entity 350. In some implementations, the resource configuration message 370 is included in a radio resource control (RRC) signaling message. In some other implementations, the resource configuration message 370 is included in a medium access control control element (MAC CE). In some other implementations, the resource configuration message 370 is included in a downlink control information (DCI). In some other implementations, the resource configuration message 370 is included in a combination of the RRC signaling message, the MAC CE, and/or the DCI.

The UE 115 generates a FD reference signal 378 based on the resource configuration message 370. In some implementations, the FD reference signal 378 includes or corresponds to a SRS. In addition to generating the FD reference signal 378, the UE 115 determines (e.g., selects) a transmission beam based on the resource configuration message 370. The transmission beam is used to transmit the FD reference signal 378 from the UE 115 to the network entity 350. In some implementations, determining the transmission beam includes determining one or more parameters of the transmission beam. In some other implementations, determining the transmission beam includes selecting the transmission beam from a plurality of pre-configured transmission beams. For example, a plurality of pre-configured transmission beams may be programmed at the UE 115, and the UE 115 may select one of the pre-configured transmission beams based on the resource configuration message 370.

In some implementations, the first parameter 372 (e.g., the spatial relation parameter) indicates a first SSB resource or a first CSI-RS resource, and the second parameter 374 (e.g., the TCI parameter) indicates a second SSB resource or a second CSI-RS resource. The resources may correspond to signals transmitted by the network entity 350 to the UE 115. For example, the network entity 350 may transmit reference signals 380 to the UE 115. The reference signals 380 may include a first SSB in the first SSB resource or a first CSI-RS in the first CSI-RS resource. Additionally, the reference signals 380 may include a second SSB in the second SSB resource or a second CSI-RS in the second CSI-RS resource. In some such implementations, as part of the process of determining the transmission beam (e.g., the UL beam via which the FD reference signal 378 is transmitted), the UE 115 (e.g., the beam selector 320) may determine a second reception beam to receive a second SSB that is transmitted by the network entity 350 in the second SSB resource or a second CSI-RS that is transmitted by the network entity 350 in the second CSI-RS resource. For example, the beam selector 320 may determine a second reception beam to receive a second reference signal of the reference signals 380 (e.g., a second SSB or a second CSI-RS). The second reception beam may be the “most suitable” reception beam to receive the second SSB or the second CSI-RS (e.g., a reception beam that most increases the DL gain or another parameter of the second SSB or the second CSI-RS). In some such implementations, the UE 115 (e.g., the beam selector 320) selects a first reception beam for receiving a first SSB that is transmitted by the network entity 350 in the first SSB resource or a first CSI-RS that is transmitted by the network entity 350 in the first CSI-RS resource. The first reception beam may have the same beam weights, the same beam direction, or both, as the transmission beam (e.g., the UL beam used to transmit the FD reference signal 378). For example, the beam selector 320 may determine a first reception beam to receive a first reference signal of the reference signals 380 (e.g., a first SSB or a first CSI-RS) having the same beam weights, the same beam direction, or both, as the transmission beam selected by the beam selector 320. In some such implementations, the transmission beam is selected such that a generated signal-to-interference and noise ratio (SINR) 306 of the first SSB or the first CSI-RS received via the first reception beam is maximized. The transmission beam may be further selected such that self-interference 308 to the second SSB or the second CSI-RS received via the second reception beam caused by a transmission signal transmitted via the transmission beam is less than a threshold. For example, the beam selector 320 may select the transmit beam such that the generated SINR 306 of the first SSB or the first CSI-RS is increased (or maximized) while ensuring that the self-interference 308 to the second SSB or the second CSI-RS caused by the transmission beam is less than the threshold 376. Selecting the transmission beam may include determining the SINR 306 for one or more potential transmission beams, determining the self-interference 308 for one or more potential transmission beams, or both. For example, selecting the transmission beam may include an iterative process, generating and solving one or more equations, another process, or a combination thereof.

In some other implementations, the first parameter 372 (e.g., the spatial relation parameter) includes or indicates a SRS resource, and the second parameter 374 (e.g., the TCI parameter) includes or indicates a SSB resource or a CSI-RS resource. The resources may correspond to signals transmitted by the network entity 350 to the UE 115. For example, the network entity 350 may transmit the reference signals 380 to the UE 115. The reference signals 380 may include a SRS resource. Additionally, the reference signals 380 may include a SSB in the SSB resource or a CSI-RS in the CSI-RS resource. In some such implementations, as part of the process of determining the transmission beam (e.g., the UL beam via which the FD reference signal 378 is transmitted), the UE 115 (e.g., the beam selector 320) may determine a reception beam to receive a SSB that is transmitted by the network entity 350 in the SSB resource or a CSI-RS that is transmitted by the network entity 350 in the CSI-RS resource. For example, the beam selector 320 may select a reception signal to receive a second reference signal of the reference signals 380 (e.g., a SSB or a CSI-RS). The reception beam may be the “most suitable” reception beam to receive the SSB or the CSI-RS (e.g., a reception beam that most increases the DL gain or another parameter of the SSB or the CSI-RS). In some such implementations, the transmission beam is selected such that a correlation coefficient 310 between the transmission beam and another transmission beam used by the UE 115 to transmit a SRS in the SRS resource is minimized. Additionally, the transmission beam is further selected such that self-interference 308 to the SSB or the CSI-RS received via the reception beam caused by a transmission signal transmitted via the transmission beam is less than a threshold. For example, the beam selector 320 may select the transmission beam (used to transmit the FD reference signal 378) to reduce (or minimize) the correlation coefficient 310 between the transmission beam and another transmission beam used to transmit a SRS while ensuring that the self-interference 308 to the SSB or the CSI-RS caused by the transmission beam is less than the threshold 376. Selecting the transmission beam may include determining the self-interference 308 for one or more potential transmission beams, determining the correlation coefficient 310 for one or more potential transmission beams, or both. For example, selecting the transmission beam may include an iterative process, generating and solving one or more equations, another process, or a combination thereof.

After selecting the transmission beam, the UE 115 transmits the FD reference signal 378 to the network entity 350 via the selected transmission beam. In some implementations, the FD reference signal 378 is receive via a different TRP coupled to the network entity 350 than the resource configuration message 370 is transmitted by. For example, the FD reference signal 378 may be transmitted from the UE 115 to the first TRP 364 (and received by the first TRP 364 for providing to the network entity 350), and the resource configuration message 370 may be transmitted by (and received from) the second TRP 366. In some such implementations, the first TRP 364 is a UL TRP and the second TRP 366 is a DL TRP. In other implementations, the first TRP 364 may be the DL TRP, and the second TRP 366 may be the UL TRP.

In some implementations, the FD reference signal 378 is transmitted a single time in response to receiving the resource configuration message 370. For example, the UE 115 may receive the resource configuration message 370 and, upon processing, determine to transmit the FD reference signal 378 a single time to the network entity 350 (e.g., to a TRP coupled to the network entity 350). In some other implementations, the UE 115 is configured to transmit the FD reference signal 378 multiple times to the network entity 350. For example, the UE 115 may transmit the FD reference signal 378 periodically. The resource configuration message 370 may indicate a parameter associated with a timing between transmissions of the FD reference signal 378. For example, the resource configuration message 370 may indicate a periodicity (e.g., a period length) between consecutive transmissions of the FD reference signal 378. In some such implementations, the UE 115 does not begin transmitting the FD reference signal 378 until an activation message is received. For example, the UE 115 may receive, from the network entity 350, and activation message and the UE 115 may activate transmission of the FD reference signal 378 in response to receiving the activation message. Additionally, or alternatively, the UE 115 may stop transmitting the FD reference signal 378 if a deactivation message is received. For example, the UE 115 may receive, from the network entity 350, a deactivation message and the UE 115 may deactivate transmission of the FD reference signal 378 in response to receiving the deactivation message.

Responsive to receiving the FD reference signal 378, the network entity 350 may determine one or more UL beams to schedule the UE 115 for UL communications, one or more DL beams to schedule the UE 115 for DL communications, or both. Scheduling both UL beams and DL beams may enable the UE 115 to communicate in a FD mode.

In some implementations, the network entity 350 (e.g., the beam selector 360) selects, based on the FD reference signal 378, a UL transmission beam of the UE for FD UL transmissions. The network entity 350 (e.g., the beam selector 360) may further select, based on the second parameter 374, a DL reception beam of the network entity 350 for FD DL transmissions. For example, the beam selector 360 may select the transmission beam associated with transmission of the FD reference signal 378 as a UL transmission beam for FD UL transmissions, and the beam selector 360 may select a DL reception beam corresponding to the configured SSB or CSI-RS indicated by the second parameter 374 as the DL reception beam for FD DL transmissions. In some implementations, the beam selector 360 selects the UL transmission beam based at least in part on UL reception performance For example, the RX performance determiner 362 may determine a UL reception performance based on a particular UL beam via which the FD reference signal 378 is received. The UL reception performance may be based on UL gain, signal-to-noise ratio (SNR), SINR, signal strength, UL throughput, other factors, or a combination thereof. The network entity 350 (e.g., the beam selector 360) compares the UL reception performance determined by the RX performance determiner 362 to a threshold. If the UL reception performance satisfies (e.g., is greater than or equal to) the threshold, the beam selector 360 selects the particular UL beam (e.g., the UL beam corresponding to the FD reference signal 378) as the scheduled UL transmission beam. If the UL reception performance fails to satisfy the threshold, the beam selector 360 may select a different UL beam for scheduling or may only select a DL beam for scheduling, as further described herein.

After selecting the UL transmission beam for FD UL transmissions and the DL reception beam for FD DL transmissions, the network entity generates a UL scheduling grant 382 and a DL scheduling grant 386. The UL scheduling grant 382 indicates a UL beam 384 (e.g., the selected UL transmission beam). The DL scheduling grant 386 indicates a DL beam 388 (e.g., the selected DL reception beam. The UL beam 384 is the transmission beam based on the resource configuration message 370, the DL beam 388 is the reception beam based on the resource configuration message 370, or both, as explained above.

The network entity 350 transmits the UL scheduling grant 382 and the DL scheduling grant 386 to the UE 115. The UE 115 receives and processes the UL scheduling grant 382 and the DL scheduling grant 386 to determine when, and via which beams, the UE 115 is scheduled to transmit UL signals and receive DL signals. After receiving the UL scheduling grant 382 and the DL scheduling grant 386, the UE 115 transmits a first signal 390 (e.g., a UL signal) to the network entity 350 and the UE 115 receives a second signal 392 (e.g., a DL signal) from the network entity 350. For example, the UE 115 may transmit the first signal 390 to the first TRP 364 coupled to the network entity 350, and the UE 115 may receive the second signal 392 from the second TRP 366 coupled to the network entity 350. Transmission of the first signal 390 and reception of the second signal 392 use at least some of the same time and frequency resources. For example, transmission of the first signal 390 and reception of the second signal 392 may overlap (e.g., be at least partially concurrent) in time, in frequency, or both. In this manner, a network entity with multiple TRPs may enable FD communications at the UE 115.

If the UL reception performance corresponding to the UL beam used to transmit FD reference signal 378 fails to satisfy the threshold, non-FD communications may be enabled at the UE 115. In some implementations, the network entity 350 (e.g., the beam selector 360) may determine that UL reception performance based on the particular UL beam via which the FD reference signal 378 is received fails to satisfy the threshold and, in response to the determination, the network entity 350 may schedule a DL reception beam for the UE 115 based on the second parameter 374. For example, the beam selector 360 may select the DL reception beam based on the SSB or the CSI-RS indicated by the second parameter 374. Additionally, in response to the determination that the UL reception performance fails to satisfy the threshold, the network entity 350 may refrain from scheduling a UL transmission beam for the UE 115. For example, the network entity 350 may only transmit the DL scheduling grant 386 (and refrain from transmitting the UL scheduling grant 382), and, in response, the UE 115 may only receive the second signal 392 from the network entity 350 during a particular time period and via a particular frequency. In some other implementations, the network entity 350 (e.g., the beam selector 360) may determine that UL reception performance based on the particular UL beam via which the FD reference signal 378 is received fails to satisfy the threshold and, in response to the determination, the network entity 350 may schedule a UL transmission beam for the UE 115 based on a UL beam of a non-FD reference signal. A non-FD reference signal may refer to a SRS that does not consider reducing self-interference at the UE 115. Additionally, in response to the determination that the UL reception performance fails to satisfy the threshold, the network entity 350 may refrain from scheduling a DL reception beam for the UE 115. For example, the network entity 350 may only transmit the UL scheduling grant 382 (and refrain from transmitting the DL scheduling grant 386), and, in response, the UE 115 may only transmit the first signal 390 to the network entity 350 during a particular time period and via a particular frequency. In this manner, if a UL beam selected based on reducing self-interference at the UE 115 fails to satisfy a UL performance threshold, only non-FD communications may be enabled at the UE 115.

Thus, FIG. 3 describes techniques for enabling FD communications at the UE 115. To illustrate, the network entity 350 transmits the resource configuration message 370 to the UE 115 and, based on the resource configuration message 370, the UE 115 determines the FD reference signal 378 (and corresponding UL transmission beam). The FD reference signal 378 and the corresponding UL transmission beam are selected such that not only is UL gain improved (e.g., maximized) to the network entity 350, but self-interference to the DL at the UE 115 is also reduced (e.g., minimized). Reducing (or minimizing or eliminating) the self-interference reduces (or eliminates) DL transmission failure and improves DL throughput in the FD mode. Thus, the aggregate UL and DL throughput in the FD mode at the UE 115 is improved as compared to wireless communication systems that do not account for self-interference when selecting reference signals and corresponding UL transmission beams.

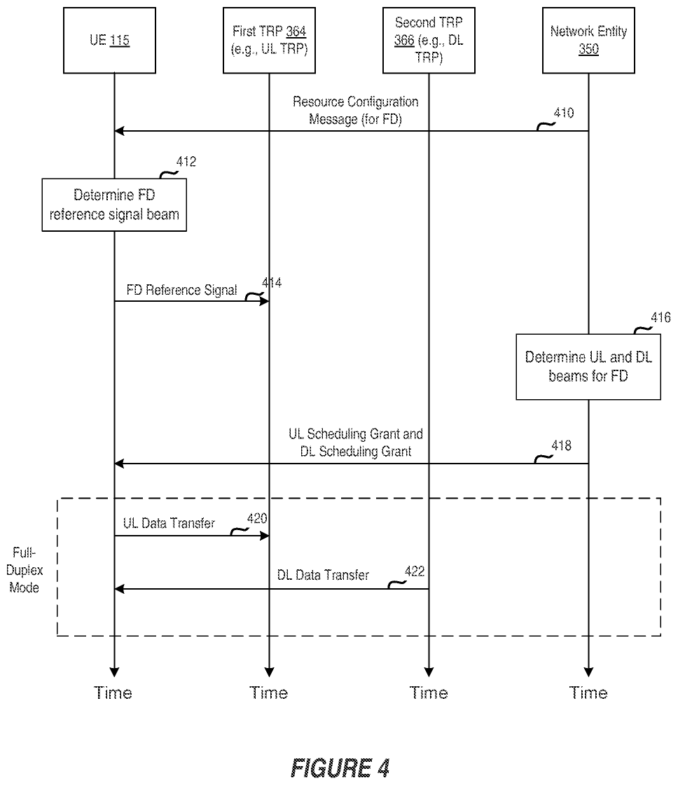

FIG. 4 is a ladder diagram illustrating an example wireless communication system for enabling a UE to operate in a FD mode with reduced (or eliminated) self-interference. FIG. 4 includes the UE 115, the first TRP 364 (e.g., a UL TRP), the second TRP 366 (e.g., a DL TRP), and the network entity 350. In some examples, the wireless communication system of FIG. 4 may implement aspects of the wireless communications system 100 or 300. Alternative examples of FIG. 4, where some steps are performed in a different order than described or are not performed at all, are also contemplated. In some cases, steps may include additional features not mentioned below, or further steps may be added.

Referring to FIG. 4, at 410, the network entity 350 sends a resource configuration message to the UE 115. The resource configuration message may include a first parameter corresponding to FD UL and a second parameter corresponding to FD DL, as explained with reference to FIG. 3. In some implementations, the first parameter includes a spatial relation parameter and the second parameter includes a TCI parameter.

At 412, the UE 115 determines a FD reference signal and corresponding UL beam via which the FD reference signal is to be transmitted based on the resource configuration message. As explained with reference to FIG. 3, the UE 115 may determine the FD reference signal and the corresponding UL beam such that a UL gain at the network entity 350 is improved (e.g., maximized) while insuring that self-interference caused by the UL beam to a DL beam is reduced (e.g., minimized). For example, the FD reference signal and the UL beam may be selected such that the SINR 306 is increased (e.g., maximized) while the self-interference 308 is decreased (e.g., minimized). As another example, the FD reference signal and the UL beam may be selected such that the correlation coefficient 310 is decreased (e.g., minimized) while the self-interference 308 is decreased (e.g., minimized). The selection may be based on the interaction of the UL beam with SSBs or CSI-RSs transmitted by the network entity 350 (and indicated by the resource configuration message).

At 414, the UE 115 transmits the FD reference signal via the selected UL beam to the first TRP 364. The first TRP 364 may provide the FD reference signal (and beam information) to the network entity 350.

At 416, the network entity 350 UL beams and DL beams for FD. For example, the network entity 350 may select the UL beam used to transmit the FD reference signal as the selected UL beam if a UL performance of the UL beam satisfies a threshold. Additionally, the network entity 350 may select the DL beam based on a beam associated with a SSB or a CSI-RS indicated by the second parameter of the resource configuration message.

At 418, the network entity 350 generates and transmits a UL scheduling grant and a DL scheduling grant to the UE 115. The UL scheduling grant indicates a UL beam to use for scheduled UL communications, and the DL scheduling grant indicates a DL beam to use for scheduled DL communications.

Responsive to receiving the UL scheduling grant and the DL scheduling grant, a FD mode is enabled at the UE 115. For example, at 420, the UE 115 performs UL data transfer with (e.g., transmits a UL signal to) the first TRP 364. Additionally, at 422, the UE 115 performs DL data transfer with (e.g., receives a DL signal from) the second TRP 366. The UL data transfer and the DL data transfer may use at least some of the same time and frequency resources. For example, the UL data transfer may overlap with (e.g., be at least partially concurrent with) the DL data transfer in the time domain, the frequency domain, or both. In this manner, the UE 115 is able to perform FD communications. Additionally, the FD communications are improved as compared to other wireless communication systems because the FD reference signal and corresponding UL beam are selected to take into account and reduce (e.g., minimize) self-interference with DL signals at the UE 115.

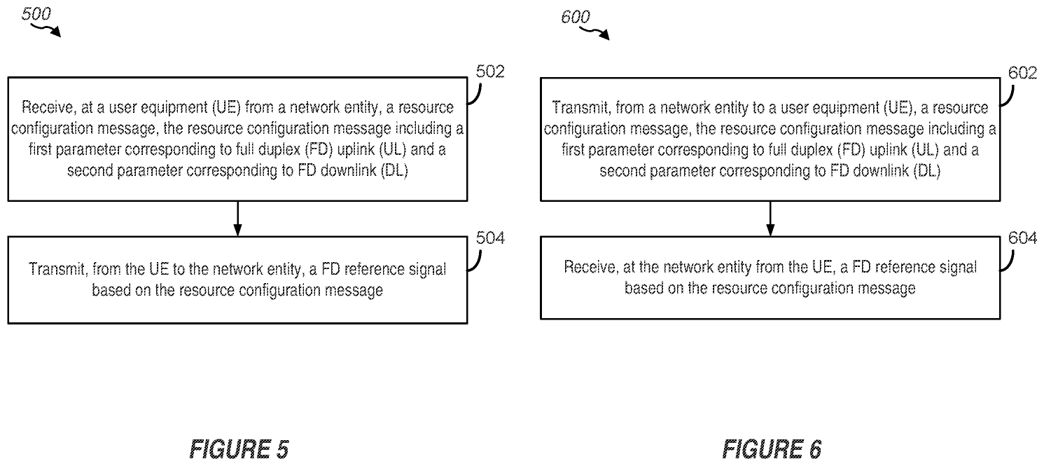

FIG. 5 is a flow diagram illustrating an example process performed by a UE for communication.

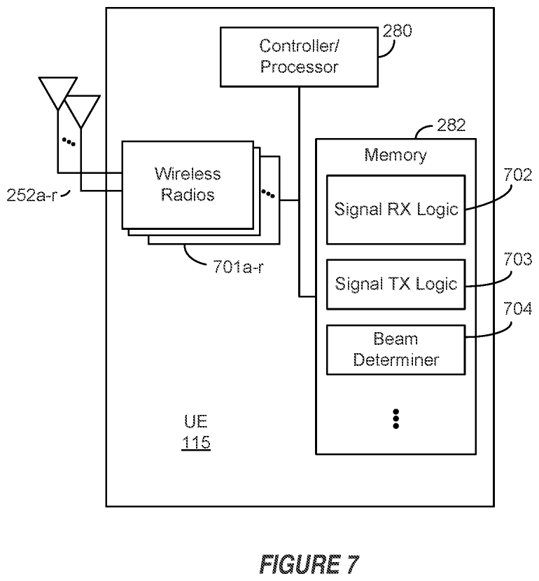

For example, example blocks of the process may cause the UE to send a FD reference signal to a network entity according to some aspects of the present disclosure. The example blocks will also be described with respect to the UE 115 as illustrated in FIG. 7. FIG. 7 is a block diagram conceptually illustrating a design of a UE. The UE of FIG. 7 may be configured to send a FD reference signal to a network entity according to one aspect of the present disclosure. The UE 115 includes the structure, hardware, and components as illustrated for the UE 115 of FIG. 2 or 3. For example, the UE 115 includes the controller/processor 280, which operates to execute logic or computer instructions stored in the memory 282, as well as controlling the components of the UE 115 that provide the features and functionality of the UE 115. The UE 115, under control of the controller/processor 280, transmits and receives signals via wireless radios 701a-r and the antennas 252a-r. The wireless radios 701a-r include various components and hardware, as illustrated in FIG. 2 for the UE 115, including the modulator/demodulators 254a-r, the MIMO detector 256, the receive processor 258, the transmit processor 264, and the TX MIMO processor 266.

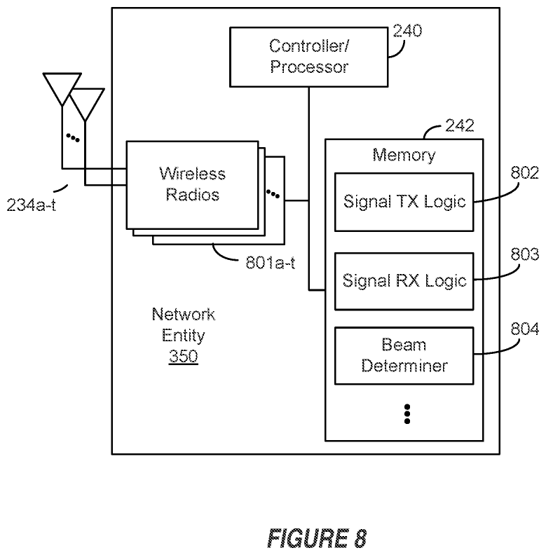

As shown, the memory 282 may include signal reception (RX) logic 702, signal transmission (TX) logic 703, and beam determiner 704. In some aspects, signal RX logic 702, signal TX logic 703, beam determiner 704, or a combination thereof, may include or correspond to the processor(s) 302. The UE 115 may receive signals from or transmit signal to one or more network entities, such as the base station 105, the network entity, a core network, a core network device, or a network entity as illustrated in FIG. 8.

Referring to FIG. 5, a flow diagram illustrating an example process 500 of UE operations for communication is shown. In some implementations, the process 500 may be performed by the UE 115. In some other implementations, the process 500 may be performed by an apparatus configured for wireless communication. For example, the apparatus may include at least one processor, and a memory coupled to the processor. The processor may be configured to perform operations of the process 500. In some other implementations, the process 500 may be performed or executed using a non-transitory computer-readable medium having program code recorded thereon. The program code may be program code executable by a computer for causing the computer to perform operations of the process 500.

As illustrated at block 502, a user equipment (UE) receives, from a network entity, a resource configuration message. The resource configuration message includes a first parameter corresponding to full duplex (FD) uplink (UL) and a second parameter corresponding to FD downlink (DL). As an example of the block 502, the UE 115 may receive a resource configuration message using wireless radios 701a-r and antennas 252a-r. To further illustrate, the UE 115 may execute, under control of the controller/processor 280, the signal RX logic 702 stored in the memory 282. The execution environment of the signal RX logic 702 provides the functionality to receive a resource configuration message from a network entity. The resource configuration message includes a first parameter corresponding to FD UL and a second parameter corresponding to FD DL.

At block 504, the UE transmits, to the network entity, a FD reference signal based on the resource configuration message. As an example of block 504, the UE 115 may transmit a FD reference signal using wireless radios 701a-r and antennas 252a-r. To further illustrate, the UE 115 may execute, under control of the controller/processor 280, the signal TX logic 703 stored in the memory 282. The execution environment of the signal TX logic 703 provides the functionality to transmit, to the network entity, a FD reference signal based on the resource configuration message. In some implementations, the UE 115 determines a UL transmission beam via which to transmit the FD reference signal based on the resource configuration message. For example, the UE 115 may execute, under control of the controller/processor 280, the beam determiner 704 stored in the memory 282. The execution environment of the beam determiner 704 provides the functionality to determine a UL transmission beam via which to transmit the FD reference signal based on the resource configuration message.

In some implementations, the process 500 may include that the resource configuration message includes a sounding reference signal (SRS) resource configuration message and the FD reference signal includes a SRS. Additionally, or alternatively, the first parameter includes a spatial relation parameter, the second parameter includes a transmission configuration information (TCI) parameter, or a combination thereof. In some such implementations, the spatial relation parameter includes an identifier of a first synchronization signal block (SSB) resource, an identifier of a first channel state information reference signal (CSI-RS) resource, or an identifier of a sounding reference signal (SRS) resource. In some such implementations, the TCI parameter includes an identifier of a second SSB resource or an identifier of a second CSI-RS resource.

In some implementations, the resource configuration message further indicates a self-interference strength threshold. In some such implementations, the self-interference strength threshold includes an absolute power value or a relative power value. Additionally, or alternatively, the resource configuration message is included in a radio resource control (RRC) signaling message, a medium access control control element (MAC CE), a downlink control information (DCI), or a combination thereof.

In some implementations, the process 500 further includes determining, at the UE, a transmission beam based on the resource configuration message. The FD reference signal is transmitted via the transmission beam. In some such implementations, determining the transmission beam includes selecting the transmission beam from a plurality of pre-configured transmission beams. In some such implementations, the first parameter indicates a first synchronization signal block (SSB) resource or a first channel state information reference signal (CSI-RS) resource, and the second parameter indicates a second SSB resource or a second CSI-resource. In some such implementations, the process 500 further includes determining, at the UE, a second reception beam to receive a second SSB that is transmitted by the network entity in the second SSB resource or a second CSI-RS that is transmitted by the network entity in the second CSI-RS resource. In some such implementations, the process 500 also includes receiving a first SSB that is transmitted by the network entity in the first SSB resource or a first CSI-RS that is transmitted by the network entity in the first CSI-RS resource via a first reception beam. The first reception beam has the same beam weights, the same beam direction, or both, as the transmission beam. In some such implementations, the transmission beam is selected such that a generated signal-to-interference and noise ratio (SINR) of the first SSB or the first CSI-RS received via the first reception beam is maximized. Alternatively, the first parameter indicates a sounding reference signal (SRS) resource, and the second parameter indicates a synchronization signal block (SSB) resource or a channel state information reference signal (CSI-RS) resource. In some such implementations, the process 500 further includes determining, at the UE, a reception beam to receive a SSB that is transmitted by the network entity in the SSB resource or a CSI-RS that is transmitted by the network entity in the CSI-RS resource. In some such implementations, the transmission beam is selected such that a correlation coefficient between the transmission beam of the UE and a transmission beam used by the UE to transmit a SRS in the SRS resource is minimized. In some such implementations, the transmission beam is further selected such that self-interference to the SSB or the CSI-RS received via the reception beam caused by a transmission signal transmitted via the transmission beam is less than a threshold.

In some implementations, the resource configuration message is received via a first transmit-receive point (TRP) coupled to the network entity, and the FD reference signal is transmitted to a second TRP coupled to the network entity. In some such implementations, the first TRP includes a DL TRP, and the second TRP includes a UL TRP.

In some implementations, the FD reference signal is transmitted a single time in response to receiving the resource configuration message. Alternatively, the FD reference signal is transmitted multiple times, and the resource configuration message indicates a parameter associated with a timing between transmissions of the FD reference signal. In some such implementations, the process 500 further includes receiving, at the UE from the network entity, an activation message and activating transmission of the FD reference signal in response to receiving the activation message. Additionally, or alternatively, the process 500 also includes receiving, at the UE from the network entity, a deactivation message and deactivating transmission of the FD reference signal in response to receiving the deactivation message.

In some implementations, the process 500 further includes receiving, at the UE from the network entity, a UL scheduling grant indicating a selected UL transmission beam and receiving, at the UE from the network entity, a DL scheduling grant indicating a selected DL reception beam. In some such implementations, the selected UL transmission beam includes a transmission beam based on the resource configuration message, the selected DL reception beam includes a reception beam based on the resource configuration message, or a combination thereof. In some such implementations, the process 500 also includes transmitting, from the UE to the network entity, a first signal via the selected UL transmission beam and receiving, at the UE from the network entity, a second signal via the selected DL reception beam. Transmission of the first signal and reception of the second signal use at least some of the same time and frequency resources.

Thus, the process 500 enables the UE to transmit a FD reference signal to a network entity via a UL transmission beam that reduces (e.g., minimizes) self-interference between concurrent UL transmissions and DL receptions. Providing the FD reference signal to the network entity enables the network entity to schedule the UE for UL and DL using beams that do not have significant self-interference. Thus, the process 500 enables the UE to operate in a FD mode without (or with less) degradation to one of the signals due to self-interference.

It is noted that one or more blocks (or operations) described with reference to FIG. 5 may be combined with one or more blocks (or operations) of another Figure. For example, one or more blocks (or operations) of FIG. 5 may be combined with one or more blocks (or operations) of another figure. As another example, one or more blocks of FIG. 5 may be combined with one or more blocks (or operations) of another of FIGS. 2-4. Additionally, or alternatively, one or more operations described above with reference to FIGS. 1-7 may be combined with one or more operations described with reference to FIG. 8.

FIG. 6 is a flow diagram illustrating an example process performed by a network entity for communication. For example, example blocks of the process may cause the network entity to receive a FD reference signal from a UE according to some aspects of the present disclosure. The example blocks will also be described with respect to the network entity 350 as illustrated in FIG. 8. FIG. 8 is a block diagram conceptually illustrating a design of a network entity 350. The network entity 350 may include the base station 105, a network, or a core network, as illustrative, non-limiting examples. The network entity 350 includes the structure, hardware, and components as illustrated for the base station 105 of FIGS. 1 and 2, the network entity 350 of FIGS. 3 and 4, or a combination thereof. For example, the network entity 350 may include the controller/processor 240, which operates to execute logic or computer instructions stored in the memory 242, as well as controlling the components of the network entity 350 that provide the features and functionality of the network entity 350. The network entity 350, under control of the controller/processor 240, transmits and receives signals via wireless radios 801a-t and the antennas 234a -t. The wireless radios 801a-t includes various components and hardware, as illustrated in FIG. 2 for the network entity 350 (such as the base station 105), including the modulator/demodulators 232a -t, the transmit processor 220, the TX MIMO processor 230, the MIMO detector 236, and the receive processor 238.

As shown, the memory 242 may include signal TX logic 802, signal RX logic 803, and beam determiner 804. In some aspects, signal TX logic 802, signal RX logic 803, beam determiner 804, or a combination thereof, may include or correspond to the processor(s) 352. The network entity 350 may receive signals from or transmit signal to one or more UEs as illustrated in FIG. 7.

Referring to FIG. 6, a flow diagram illustrating an example process 600 of network entity operations for communication is shown. In some implementations, the process 600 may be performed by the network entity 350. In some other implementations, the process 600 may be performed by an apparatus configured for wireless communication. For example, the apparatus may include at least one processor, and a memory coupled to the processor. The processor may be configured to perform operations of the process 600. In some other implementations, the process 600 may be performed or executed using a non-transitory computer-readable medium having program code recorded thereon. The program code may be program code executable by a computer for causing the computer to perform operations of the process 600.

As illustrated at block 602, a network entity transmits, to a UE, a resource configuration message. The resource configuration message includes a first parameter corresponding to full duplex (FD) uplink (UL) and a second parameter corresponding to FD downlink (DL). As an example of the block 602, the network entity 350 may transmit a resource configuration message using wireless radios 801a-t and antennas 234a -t. To further illustrate, the network entity 350 may execute, under control of the controller/processor 240, the signal TX logic 802 stored in the memory 242. The execution environment of the signal TX logic 802 provides the functionality to transmit a resource configuration message to a UE. The resource configuration message includes a first parameter corresponding to FD UL and a second parameter corresponding to FD DL.

At block 604, the network entity receives, from the UE, a FD reference signal based on the resource configuration message. As an example of block 604, the network entity 350 may receive a FD reference signal using wireless radios 801a-t and antennas 234a -t. To further illustrate, the network entity 350 may execute, under control of the controller/processor 240, the signal RX logic 803 stored in the memory 242. The execution environment of the signal RX logic 803 provides the functionality to receive, from the UE, a FD reference signal based on the resource configuration message. In some implementations, the network entity 350 determines a UL transmission beam, a DL reception beam, or both for scheduling for the UE based on the FD reference signal. For example, the network entity 350 may execute, under control of the controller/processor 240, the beam determiner 804 stored in the memory 242. The execution environment of the beam determiner 804 provides the functionality to determine a UL transmission beam, a DL reception beam, or both, for scheduling for the UE based on the FD reference signal.

In some implementations, the process 600 may include that the resource configuration message includes a sounding reference signal (SRS) resource configuration message, and the FD reference signal includes a SRS. Additionally, or alternatively, the first parameter includes a spatial relation parameter, the second parameter includes a transmission configuration information (TCI) parameter, or a combination thereof. In some such implementations, the spatial relation parameter includes an identifier of a synchronization signal block (SSB) resource, an identifier of a channel state information reference signal (CSI-RS) resource, or an identifier of a sounding reference signal (SRS) resource. In some such implementations, the TCI parameter includes an identifier of a second SSB resource or an identifier of a second CSI-RS resource.

In some implementations, the resource configuration message further includes a self-interference strength threshold. In some such implementations, the self-interference strength threshold includes an absolute power value. Alternatively, the self-interference strength threshold includes a relative power value. Additionally, or alternatively, the resource configuration message is included in a radio resource control (RRC) signaling message, a medium access control control element (MAC CE), a downlink control information (DCI), or a combination thereof.

In some implementations, the process 600 further includes selecting, at the network entity and based on the FD reference signal, a UL transmission beam of the UE for FD UL transmissions and selecting, at the network entity and based on the second parameter, a DL reception beam of the network entity for FD DL transmissions. In some such implementations, the process 600 also includes determining, at the network entity, a UL reception performance based on a particular UL beam via which the FD reference signal is received, comparing the UL reception performance to a threshold, and selecting the particular UL beam as the UL transmission beam based on the UL reception performance satisfying the threshold. In some such implementations, the process 600 further includes transmitting, from the network entity to the UE, a UL scheduling grant indicating the selected UL transmission beam and transmitting, from the network entity to the UE, a DL scheduling grant indicating the selected DL reception beam. In some such implementations, the process 600 also includes receiving, at a first transmit-receive point (TRP) coupled to the network entity from the UE, a first signal via the selected UL transmission beam and transmitting, from a second TRP coupled to the network entity to the UE, a second signal via the selected DL reception beam. Reception of the first signal and transmission of the second signal use at least some of the same time and frequency resources. In some such implementations, the first TRP includes a UL TRP, and the second TRP includes a DL TRP.

In some implementations, the process 600 further includes determining that UL reception performance based on a particular UL beam via which the FD reference signal is received fails to satisfy a threshold and scheduling a DL reception beam for the UE based on the second parameter. In some such implementations, the process 600 also includes in response to determining that the UL reception performance fails to satisfy the threshold, refraining from scheduling a UL transmission beam for the UE. Alternatively, the process 600 further includes determining that UL reception performance based on a particular UL beam via which the FD reference signal is received fails to satisfy a threshold and scheduling a UL transmission beam for the UE based on a UL beam of a non-FD reference signal. In some such implementations, the process 600 also includes refraining from scheduling a DL reception beam for the UE.

Thus, the process 600 enables the network entity to receive a FD reference signal from a UE via a UL transmission beam that reduces (e.g., minimizes) self-interference between concurrent UL transmissions and DL receptions at the UE. Based on the FD reference signal, the network entity schedules the UE for UL and DL using beams that do not have significant self-interference. Thus, the process 600 enables the network entity to assist the UE in operating in a FD mode without (or with less) degradation to one of the signals due to self-interference.

It is noted that one or more blocks (or operations) described with reference to FIG. 6 may be combined with one or more blocks (or operations) of another Figure. For example, one or more blocks of FIG. 6 may be combined with one or more blocks (or operations) of another of FIGS. 2-4. Additionally, or alternatively, one or more operations described above with reference to FIGS. 1-4 and 8 may be combined with one or more operations described with reference to FIG. 7.

In some aspects, techniques for a reference signal scheme that enables full-duplex (FD) operation at a user equipment while reducing self-interference may include additional aspects, such as any single aspect or any combination of aspects described below and/or in connection with one or more other processes or devices described elsewhere herein. Some aspects may include an apparatus, such as a user equipment (UE), configured to receive, from a network entity, a resource configuration message. The resource configuration message includes a first parameter corresponding to full duplex (FD) uplink (UL) and a second parameter corresponding to FD downlink (DL). The apparatus is also configured to transmit, to the network entity, a FD reference signal based on the resource configuration message. In some implementations, the apparatus includes a wireless device, such as by a user equipment (UE). In some implementations, the apparatus may include at least one processor, and a memory coupled to the processor. The processor may be configured to perform operations described herein with respect to the wireless device. In some other implementations, the apparatus may include a non-transitory computer-readable medium having program code recorded thereon and the program code may be executable by a computer for causing the computer to perform operations described herein with reference to the wireless device. In some implementations, the apparatus may include one or more means configured to perform operations described herein.

In a first aspect, the resource configuration message includes a sounding reference signal (SRS) resource configuration message, and the FD reference signal includes a SRS.

In a second aspect, alone or in combination with the first aspect, the first parameter includes a spatial relation parameter, the second parameter includes a transmission configuration information (TCI) parameter, or a combination thereof.

In a third aspect, alone or in combination with the second aspect, the spatial relation parameter includes an identifier of a first synchronization signal block (SSB) resource, an identifier of a first channel state information reference signal (CSI-RS) resource, or an identifier of a sounding reference signal (SRS) resource.

In a fourth aspect, alone or in combination with the third aspect, the TCI parameter includes an identifier of a second SSB resource or an identifier of a second CSI-RS resource.

In a fifth aspect, alone or in combination with one or more of the first through fourth aspects, the resource configuration message further indicates a self-interference strength threshold.

In a sixth aspect, alone or in combination with the fifth aspect, the self-interference strength threshold includes an absolute power value or a relative power value.

In a seventh aspect, alone or in combination with one or more of the first through sixth aspects, the resource configuration message is included in a radio resource control (RRC) signaling message, a medium access control control element (MAC CE), a downlink control information (DCI), or a combination thereof.

In an eighth aspect, alone or in combination with one or more of the first through seventh aspects, the apparatus determines a transmission beam based on the resource configuration message. The FD reference signal is transmitted via the transmission beam.

In a ninth aspect, alone or in combination with the eighth aspect, determining the transmission beam includes selecting the transmission beam from a plurality of pre-configured transmission beams.

In a tenth aspect, alone or in combination with one or more of the eighth through ninth aspects, the first parameter indicates a first synchronization signal block (SSB) resource or a first channel state information reference signal (CSI-RS) resource, and the second parameter indicates a second SSB resource or a second CSI-resource.

In an eleventh aspect, alone or in combination with the tenth aspect, the apparatus determines a second reception beam to receive a second SSB that is transmitted by the network entity in the second SSB resource or a second CSI-RS that is transmitted by the network entity in the second CSI-RS resource.

In a twelfth aspect, alone or in combination with the eleventh aspect, the apparatus receives a first SSB that is transmitted by the network entity in the first SSB resource or a first CSI-RS that is transmitted by the network entity in the first CSI-RS resource via a first reception beam. The first reception beam has the same beam weights, the same beam direction, or both, as the transmission beam.

In a thirteenth aspect, alone or in combination with the twelfth aspect, the transmission beam is selected such that a generated signal-to-interference and noise ratio (SINR) of the first SSB or the first CSI-RS received via the first reception beam is maximized.

In a fourteenth aspect, alone or in combination with the thirteenth aspect, the transmission beam is further selected such that self-interference to the second SSB or the second CSI-RS received via the second reception beam caused by a transmission signal transmitted via the transmission beam is less than a threshold.

In a fifteenth aspect, alone or in combination with one or more of the eighth through ninth aspects, the first parameter indicates a sounding reference signal (SRS) resource, and the second parameter indicates a synchronization signal block (SSB) resource or a channel state information reference signal (CSI-RS) resource.

In a sixteenth aspect, alone or in combination with the fifteenth aspect, the apparatus determines a reception beam to receive a SSB that is transmitted by the network entity in the SSB resource or a CSI-RS that is transmitted by the network entity in the CSI-RS resource.

In a seventeenth aspect, alone or in combination with the sixteenth aspect, the transmission beam is selected such that a correlation coefficient between the transmission beam of the UE and a transmission beam used by the UE to transmit a SRS in the SRS resource is minimized.

In an eighteenth aspect, alone or in combination with the seventeenth aspect, the transmission beam is further selected such that self-interference to the SSB or the CSI-RS received via the reception beam caused by a transmission signal transmitted via the transmission beam is less than a threshold.

In a nineteenth aspect, alone or in combination with one or more of the eighth through eighteenth aspects, the resource configuration message is received via a first transmit-receive point (TRP) coupled to the network entity, and the FD reference signal is transmitted to a second TRP coupled to the network entity.

In a twentieth aspect, alone or in combination with the nineteenth aspect, the first TRP includes a DL TRP, and the second TRP includes a UL TRP.

In a twenty-first aspect, alone or in combination with one or more of the first through twentieth aspects, the FD reference signal is transmitted a single time in response to receiving the resource configuration message.

In a twenty-second aspect, alone or in combination with one or more of the first through twentieth aspects, the FD reference signal is transmitted multiple times, and the resource configuration message indicates a parameter associated with a timing between transmissions of the FD reference signal.

In a twenty-third aspect, alone or in combination with the twenty-second aspect, the apparatus receives, from the network entity, an activation message and activates transmission of the FD reference signal in response to receiving the activation message.

In a twenty-fourth aspect, alone or in combination with one or more of the twenty-second through twenty-third aspects, the apparatus receives, from the network entity, a deactivation message and deactivates transmission of the FD reference signal in response to receiving the deactivation message.

In a twenty-fifth aspect, alone or in combination with one or more of the first through twenty-fourth aspects, the apparatus receives, from the network entity, a UL scheduling grant indicating a selected UL transmission beam and receives, from the network entity, a DL scheduling grant indicating a selected DL reception beam.

In a twenty-sixth aspect, alone or in combination with the twenty-fifth aspect, the selected UL transmission beam includes a transmission beam based on the resource configuration message, the selected DL reception beam includes a reception beam based on the resource configuration message, or a combination thereof.

In a twenty-seventh aspect, alone or in combination with one or more of the twenty-fifth through twenty-sixth aspects, the apparatus transmits, to the network entity, a first signal via the selected UL transmission beam and

In a twenty-eighth aspect, alone or in combination with one or more of the first through twenty-seventh aspects, the apparatus receives, from the network entity, a second signal via the selected DL reception beam. Transmission of the first signal and reception of the second signal use at least some of the same time and frequency resources.

In some aspects, an apparatus configured for wireless communication, such as a network entity, is configured to transmit, to a user equipment (UE), a resource configuration message. The resource configuration message includes a first parameter corresponding to full duplex (FD) uplink (UL) and a second parameter corresponding to FD downlink (DL). The apparatus is also configured to receive, from the UE, a FD reference signal based on the resource configuration message. In some implementations, the apparatus includes a wireless device, such as a network entity. In some implementations, the apparatus may include at least one processor, and a memory coupled to the processor. The processor may be configured to perform operations described herein with respect to the wireless device. In some other implementations, the apparatus may include a non-transitory computer-readable medium having program code recorded thereon and the program code may be executable by a computer for causing the computer to perform operations described herein with reference to the wireless device. In some implementations, the apparatus may include one or more means configured to perform operations described herein.

In a twenty-ninth aspect, the resource configuration message includes a sounding reference signal (SRS) resource configuration message, and the FD reference signal includes a SRS.

In a thirtieth aspect, alone or in combination with the twenty-ninth aspect, the first parameter includes a spatial relation parameter, the second parameter includes a transmission configuration information (TCI) parameter, or a combination thereof.

In a thirty-first aspect, alone or in combination with the thirtieth aspect, the spatial relation parameter includes an identifier of a synchronization signal block (SSB) resource, an identifier of a channel state information reference signal (CSI-RS) resource, or an identifier of a sounding reference signal (SRS) resource.

In a thirty-second aspect, alone or in combination with the thirty-first aspect, the TCI parameter includes an identifier of a second SSB resource or an identifier of a second CSI-RS resource.

In a thirty-third aspect, alone or in combination with one or more of the twenty-ninth through thirty-second aspects, the resource configuration message further includes a self-interference strength threshold.

In a thirty-fourth aspect, alone or in combination with the thirty-third aspect, the self-interference strength threshold includes an absolute power value.

In a thirty-fifth aspect, alone or in combination with the thirty-third aspect, the self-interference strength threshold includes a relative power value.

In a thirty-sixth aspect, alone or in combination with one or more of the twenty-ninth through thirty-fifth aspects, the resource configuration message is included in a radio resource control (RRC) signaling message, a medium access control control element (MAC CE), a downlink control information (DCI), or a combination thereof.

In a thirty-seventh aspect alone or in combination with one or more of the twenty-ninth through thirty-sixth aspects, the apparatus selects, based on the FD reference signal, a UL transmission beam of the UE for FD UL transmissions and selects, based on the second parameter, a DL reception beam of the network entity for FD DL transmissions.

In a thirty-eighth aspect, alone or in combination with the thirty-seventh aspect, the apparatus determines a UL reception performance based on a particular UL beam via which the FD reference signal is received, compares the UL reception performance to a threshold, and selects the particular UL beam as the UL transmission beam based on the UL reception performance satisfying the threshold.

In a thirty-ninth aspect, alone or in combination with the thirty-eighth aspect, the apparatus transmits, to the UE, a UL scheduling grant indicating the selected UL transmission beam and transmits, to the UE, a DL scheduling grant indicating the selected DL reception beam.

In a fortieth aspect, alone or in combination with the thirty-ninth aspect, the apparatus receives, at a first transmit-receive point (TRP) from the UE, a first signal via the selected UL transmission beam and transmits, from a second TRP to the UE, a second signal via the selected DL reception beam. Reception of the first signal and transmission of the second signal use at least some of the same time and frequency resources.

In a forty-first aspect, alone or in combination with the fortieth aspect, the first TRP includes a UL TRP, and the second TRP includes a DL TRP.

In a forty-second aspect alone or in combination with one or more of the twenty-ninth through thirty-sixth aspects, the apparatus determines that UL reception performance based on a particular UL beam via which the FD reference signal is received fails to satisfy a threshold and schedules a DL reception beam for the UE based on the second parameter.

In a forty-third aspect alone or in combination with the forty-second aspect, the apparatus, in response to determining that the UL reception performance fails to satisfy the threshold, refrains from scheduling a UL transmission beam for the UE.

In a forty-fourth aspect alone or in combination with one or more of the twenty-ninth through thirty-sixth aspects, the apparatus determines that UL reception performance based on a particular UL beam via which the FD reference signal is received fails to satisfy a threshold and schedules a UL transmission beam for the UE based on a UL beam of a non-FD reference signal.

In a forty-fifth aspect, alone or in combination with the forty-fourth aspect, the apparatus refrains from scheduling a DL reception beam for the UE.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, etc., or any combination thereof. In addition, features discussed herein may be implemented via specialized processor circuitry, via executable instructions, or combinations thereof.

Components, the functional blocks, and the modules described herein (such as components of FIGS. 1-4, 7, and 8) may include processors, electronics devices, hardware devices, electronics components, logical circuits, memories, software codes, firmware codes, etc., or any combination thereof. In addition, features discussed herein relating to components, the functional blocks, and the modules described herein (such as components of FIGS. 1-4, 7, and 8) may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication performed by a user equipment (UE), the method comprising:
receiving, from a network entity, a resource configuration message, the resource configuration message including a first parameter corresponding to full duplex (FD) uplink (UL) and a second parameter corresponding to FD downlink (DL); and
transmitting, from the UE to the network entity, a FD reference signal based on the resource configuration message.

2. The method of claim 1, wherein the resource configuration message comprises a sounding reference signal (SRS) resource configuration message, and wherein the FD reference signal comprises a SRS.

3. The method of claim 1, wherein the first parameter comprises a spatial relation parameter, the second parameter comprises a transmission configuration information (TCI) parameter, or a combination thereof.

4. The method of claim 3, wherein:
the spatial relation parameter includes an identifier of a first synchronization signal block (SSB) resource, an identifier of a first channel state information reference signal (CSI-RS) resource, or an identifier of a sounding reference signal (SRS) resource; and
the TCI parameter includes an identifier of a second SSB resource or an identifier of a second CSI-RS resource.

5. (canceled)

6. The method of claim 1, wherein:
the resource configuration message further indicates a self-interference strength threshold and
the self-interference strength threshold comprises an absolute power value or a relative power value.

7-9. (canceled)

10. The method of claim 1, further comprising:
determining a transmission beam based on the resource configuration message, wherein the FD reference signal is transmitted via the transmission beam; and
wherein determining the transmission beam comprises selecting the transmission beam from a plurality of pre-configured transmission beams.

11. The method of claim 1, further comprising:
determining a transmission beam based on the resource configuration message, wherein the FD reference signal is transmitted via the transmission beam; and
wherein the first parameter indicates a first synchronization signal block (SSB) resource or a first channel state information reference signal (CSI-RS) resource, and wherein the second parameter indicates a second SSB resource or a second CSI-resource.

12. The method of claim 11, further comprising:
determining a second reception beam to receive a second SSB that is transmitted by the network entity in the second SSB resource or a second CSI-RS that is transmitted by the network entity in the second CSI-RS resource; and
receiving a first SSB that is transmitted by the network entity in the first SSB resource or a first CSI-RS that is transmitted by the network entity in the first CSI-RS resource via a first reception beam, the first reception beam having the same beam weights, the same beam direction, or both, as the transmission beam.

13. (canceled)

14. The method of claim 12, wherein:
the transmission beam is selected such that a generated signal-to-interference and noise ratio (SINR) of the first SSB or the first CSI-RS received via the first reception beam is maximized; and
the transmission beam is further selected such that self-interference to the second SSB or the second CSI-RS received via the second reception beam caused by a transmission signal transmitted via the transmission beam is less than a threshold.

15. (canceled)

16. The method of claim 1, further comprising:
determining a transmission beam based on the resource configuration message, wherein the FD reference signal is transmitted via the transmission beam; and
wherein the first parameter indicates a sounding reference signal (SRS) resource, and wherein the second parameter indicates a synchronization signal block (SSB) resource or a channel state information reference signal (CSI-RS) resource.

17. The method of claim 16, further comprising:
determining a reception beam to receive a SSB that is transmitted by the network entity in the SSB resource or a CSI-RS that is transmitted by the network entity in the CSI-RS resource;
wherein the transmission beam is selected such that a correlation coefficient between the transmission beam of the UE and a transmission beam used by the UE to transmit a SRS in the SRS resource is minimized; and
wherein the transmission beam is further selected such that self-interference to the SSB or the CSI-RS received via the reception beam caused by a transmission signal transmitted via the transmission beam is less than a threshold.

18-19. (canceled)

20. The method of claim 1, further comprising
determining a transmission beam based on the resource configuration message, wherein the FD reference signal is transmitted via the transmission beam; and
wherein the resource configuration message is received via a first transmit-receive point (TRP) coupled to the network entity, and wherein the FD reference signal is transmitted to a second TRP coupled to the network entity.

21-28. (canceled)

29. An apparatus configured for wireless communication, comprising:
at least one processor; and
a memory coupled to the at least one processor,
wherein the at least one processor is configured to:
receive, at a user equipment (UE) from a network entity, a resource configuration message, the resource configuration message including a first parameter corresponding to full duplex (FD) uplink (UL) and a second parameter corresponding to FD downlink (DL); and
initiate transmission, from the UE to the network entity, of a FD reference signal based on the resource configuration message.

30. The apparatus of claim 29, wherein the resource configuration message comprises a sounding reference signal (SRS) resource configuration message, and wherein the FD reference signal comprises a SRS.

31. The apparatus of claim 29, wherein the first parameter comprises a spatial relation parameter, the second parameter comprises a transmission configuration information (TCI) parameter, or a combination thereof.

32. The apparatus of claim 31, wherein:
the spatial relation parameter includes an identifier of a first synchronization signal block (SSB) resource, an identifier of a first channel state information reference signal (CSI-RS) resource, or an identifier of a sounding reference signal (SRS) resource; and
the TCI parameter includes an identifier of a second SSB resource or an identifier of a second CSI-RS resource.

33. (canceled)

34. The apparatus of claim 29, wherein:
the resource configuration message further indicates a self-interference strength threshold; and
the self-interference strength threshold comprises an absolute power value or a relative power value.

35-37. (canceled)

38. The apparatus of claim 29, wherein:
the at least one processor is further configured to determine, at the UE, a transmission beam based on the resource configuration message, and wherein the FD reference signal is transmitted via the transmission beam; and
determining the transmission beam comprises selecting the transmission beam from a plurality of pre-configured transmission beams.

39. The apparatus of claim 29, wherein:
the at least one processor is further configured to determine, at the UE, a transmission beam based on the resource configuration message, and wherein the FD reference signal is transmitted via the transmission beam; and
the first parameter indicates a first synchronization signal block (SSB) resource or a first channel state information reference signal (CSI-RS) resource, and wherein the second parameter indicates a second SSB resource or a second CSI-resource.

40. The apparatus of claim 39, wherein the at least one processor is further configured to:
determine, at the UE, a second reception beam to receive a second SSB that is transmitted by the network entity in the second SSB resource or a second CSI-RS that is transmitted by the network entity in the second CSI-RS resource; and
receive a first SSB that is transmitted by the network entity in the first SSB resource or a first CSI-RS that is transmitted by the network entity in the first CSI-RS resource via a first reception beam, the first reception beam having the same beam weights, the same beam direction, or both, as the transmission beam.

41. (canceled)

42. The apparatus of claim 40, wherein:
the transmission beam is selected such that a generated signal-to-interference and noise ratio (SINR) of the first SSB or the first CSI-RS received via the first reception beam is maximized and
the transmission beam is further selected such that self-interference to the second SSB or the second CSI-RS received via the second reception beam caused by a transmission signal transmitted via the transmission beam is less than a threshold.

43. (canceled)

44. The apparatus of claim 29, wherein:
the at least one processor is further configured to determine, at the UE, a transmission beam based on the resource configuration message, and wherein the FD reference signal is transmitted via the transmission beam; and
the first parameter indicates a sounding reference signal (SRS) resource, and wherein the second parameter indicates a synchronization signal block (SSB) resource or a channel state information reference signal (CSI-RS) resource.

45. The apparatus of claim 44, wherein:
the at least one processor is further configured to determine, at the UE, a reception beam to receive a SSB that is transmitted by the network entity in the SSB resource or a CSI-RS that is transmitted by the network entity in the CSI-RS resource
the transmission beam is selected such that a correlation coefficient between the transmission beam of the UE and a transmission beam used by the UE to transmit a SRS in the SRS resource is minimized; and
the transmission beam is further selected such that self-interference to the SSB or the CSI-RS received via the reception beam caused by a transmission signal transmitted via the transmission beam is less than a threshold.

46-47. (canceled)

48. The apparatus of claim 29, wherein:
the at least one processor is further configured to determine, at the UE, a transmission beam based on the resource configuration message, and wherein the FD reference signal is transmitted via the transmission beam; and
the resource configuration message is received via a first transmit-receive point (TRP) coupled to the network entity, and wherein the FD reference signal is transmitted to a second TRP coupled to the network entity.

49-58. (canceled)

59. A method of wireless communication, the method comprising:
transmitting, from a network entity to a user equipment (UE), a resource configuration message, the resource configuration message including a first parameter corresponding to full duplex (FD) uplink (UL) and a second parameter corresponding to FD downlink (DL); and
receiving, at the network entity from the UE, a FD reference signal based on the resource configuration message.

60. The method of claim 59, wherein the resource configuration message comprises a sounding reference signal (SRS) resource configuration message, and wherein the FD reference signal comprises a SRS.

61. The method of claim 59, wherein the first parameter comprises a spatial relation parameter, the second parameter comprises a transmission configuration information (TCI) parameter, or a combination thereof.

62. The method of claim 61, wherein:
the spatial relation parameter includes an identifier of a synchronization signal block (SSB) resource, an identifier of a channel state information reference signal (CSI-RS) resource, or an identifier of a sounding reference signal (SRS) resource; and
the TCI parameter includes an identifier of a second SSB resource or an identifier of a second CSI-RS resource.

63. (canceled)

64. The method of claim 59, wherein the resource configuration message further includes a self-interference strength threshold.

65. The method of claim 64, wherein the self-interference strength threshold comprises an absolute power value or a relative power value.

66-76. (canceled)

77. An apparatus configured for wireless communication, comprising:
at least one processor; and
a memory coupled to the at least one processor,
wherein the at least one processor is configured to:
initiate transmission, from a network entity to a user equipment (UE), of a resource configuration message, the resource configuration message including a first parameter corresponding to full duplex (FD) uplink (UL) and a second parameter corresponding to FD downlink (DL); and
receive, at the network entity from the UE, a FD reference signal based on the resource configuration message.

78. The apparatus of claim 77, wherein the resource configuration message comprises a sounding reference signal (SRS) resource configuration message, and wherein the FD reference signal comprises a SRS.

79. The apparatus of claim 77, wherein the first parameter comprises a spatial relation parameter, the second parameter comprises a transmission configuration information (TCI) parameter, or a combination thereof.

80. The apparatus of claim 79, wherein:
the spatial relation parameter includes an identifier of a synchronization signal block (SSB) resource, an identifier of a channel state information reference signal (CSI-RS) resource, or an identifier of a sounding reference signal (SRS) resource; and
the TCI parameter includes an identifier of a second SSB resource or an identifier of a second CSI-RS resource.

81. (canceled)

82. The apparatus of claim 77, wherein:
the resource configuration message further includes a self-interference strength threshold and
the self-interference strength threshold comprises an absolute power value or a relative power value.

83-96. (canceled)
